(19) United States
(12) Patent Application Publication
(10) Pub. No.: US 2021/0065067 A1
(43) Pub. Date: Mar. 4, 2021

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventor: Yutaro TATEBAYASHI, Kanagawa (JP)

(73) Assignee: FUJI XEROX CO., LTD., Tokyo (JP)

(21) Appl. No.: 16/744,206

(22) Filed: Jan. 16, 2020

(30) Foreign Application Priority Data
Sep. 4, 2019 (JP) 2019-161583

(51) Int. Cl. G06Q 10/02; G06F 16/9537; G06F 16/29; G06Q 10/10

(52) U.S. Cl. CPC G06Q 10/02; G06Q 10/109; G06F 16/29; G06F 16/9537

(57) ABSTRACT

An information processing system includes: an acquisition unit that acquires at least two pieces of information of a departure time, an arrival time, or a use time of a work place, as information when a user moves from a departure place to a destination place; and an output unit that outputs information on a usable work place together with information on a work allowance time of the usable work place, the usable work place being a place that is usable when the user moves from the departure place to the destination place, the usable work place being specified, from among a plurality of predetermined work places, based on the information acquired by the acquisition unit.

### CROSS-REFERENCE TO RELATED APPLICATIONS

This application is based on and claims priority under 35 USC 119 from Japanese Patent Application No. 2019-161583 filed Sep. 4, 2019.

### BACKGROUND

### (i) Technical Field

The present invention relates to an information processing system and a non-transitory computer readable medium storing a program.

### (ii) Related Art

As a technique of guiding a movement method considering a use of accommodation facilities, for example, JP2002-175383A discloses an accommodation facility guidance system 1 including a mobile terminal 12, an accommodation facility guidance server 11, and an accommodation facility terminal 13. In the accommodation facility guidance system 1, the accommodation facility guidance server 11 extracts information on a transportation facility and an accommodation facility based on a search condition transmitted from the mobile terminal 12 and transmits the information to the mobile terminal 12, the mobile terminal 12 selects an accommodation facility from a received search result and transmits reservation information to the accommodation facility guidance server 11, and the accommodation facility guidance server 11 mediates a reservation procedure between the mobile terminal 12 and the accommodation facility terminal 13.

### SUMMARY

In related art, information on a route on which a user moves from a departure place to a destination place may be output, or information on facilities around a destination place may be output. However, in a case where a user desires to work at a work place when moving from a departure place to a destination place, it is difficult to recognize a usable work place based on a departure time or an arrival time.

Aspects of non-limiting embodiments of the present disclosure relate to an information processing system and a non-transitory computer readable medium storing a program that make it easier to recognize a usable work place when a user moves from a departure place to a destination place, as compared with a case where information on facilities around a destination place is output regardless of whether or not there is a usable work place when a user moves from a departure place to a destination place.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: an acquisition unit that acquires at least two pieces of information of a departure time, an arrival time, or a use time of a work place, as information when a user moves from a departure place to a destination place; and an output unit that outputs information on a usable work place which is usable when the user moves from the departure place to the destination place together with information on a work allowance time of the usable work place, the usable work place being a place that is usable when the user moves from the departure place to the destination place, the usable work place being specified, from among a plurality of predetermined work places, based on the information acquired by the acquisition unit.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system according to the present exemplary embodiment;

FIG. 2 is a diagram illustrating a hardware configuration example of a server apparatus according to the present exemplary embodiment;

FIG. 3 is a block diagram illustrating a functional configuration example of the server apparatus according to the present exemplary embodiment;

FIG. 4 is a flowchart illustrating an example of a processing procedure of the server apparatus according to the present exemplary embodiment;

FIGS. 5A and 5B are diagrams for explaining specific examples of processing of a search unit of the server apparatus;

FIGS. 6A and 6B are diagrams for explaining specific examples of processing of the search unit of the server apparatus;

FIGS. 7A and 7B are diagrams for explaining specific examples of processing of the search unit of the server apparatus;

FIGS. 8A and 8B are diagrams for explaining specific examples of processing of the search unit of the server apparatus;

FIG. 9 is a diagram illustrating a display example of a search result;

FIG. 10 is a diagram illustrating a display example of a search result;

FIG. 11 is a diagram illustrating a display example of a search result;

FIG. 12 is a diagram illustrating a display example of a search result; and

FIG. 13 is a diagram illustrating a display example in a case where a position of a work place is displayed on a map.

### DETAILED DESCRIPTION

Hereinafter, an exemplary embodiment of the present invention will be described in detail with reference to the accompanying drawings.

Overall Configuration of Information Processing System

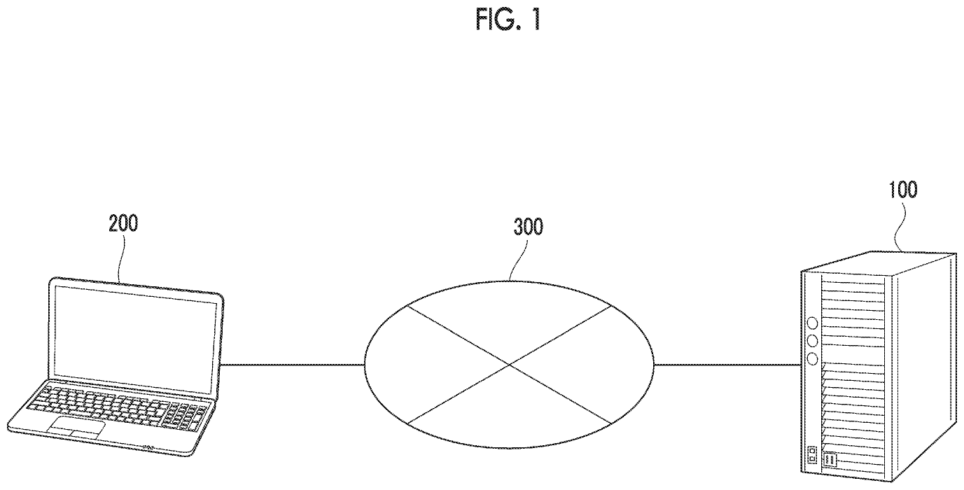

FIG. 1 is a diagram illustrating an example of an overall configuration of an information processing system 1 according to the present exemplary embodiment. As illustrated in FIG. 1, in the information processing system 1 according to the present exemplary embodiment, a server apparatus 100 and a user terminal 200 are connected to each other via a network 300.

The server apparatus 100 is a server apparatus that allows an access to a website and provides website data according to a request from the user terminal 200. Specifically, the server apparatus 100 provides data of a website (hereinafter, referred to as a “search site”) outputting information on a movement route from a departure place to a destination place. Although details will be described later, the search site also outputs information on a work place which is usable when the user moves from the departure place to the destination place.

The user terminal 200 is a computer which is operated by a user. Examples of the user terminal 200 include a personal computer (PC), a tablet terminal, a smartphone, and the like. The user performs an operation of causing the search site to be displayed by accessing the server apparatus 100 via the user terminal 200, or performs an operation of inputting a search condition on the search site.

The network 300 is a communication unit used for information communication between the server apparatus 100 and the user terminal 200, and is, for example, the Internet, a public line, a local area network (LAN), or the like.

Hardware Configuration of Server Apparatus

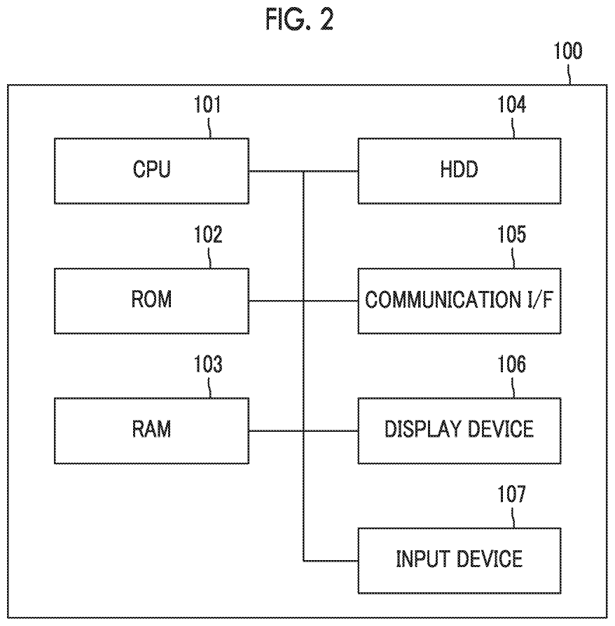

FIG. 2 is a diagram illustrating a hardware configuration example of the server apparatus 100 according to the present exemplary embodiment.

As illustrated in FIG. 2, the server apparatus 100 includes a central processing unit (CPU) 101 as a calculation unit, a read only memory (ROM) 102 as a storage area in which a program such as a basic input output system (BIOS) is stored, and a random access memory (RAM) 103 as an execution area of a program. Further, the server apparatus 100 includes an HDD (hard disk drive) 104 as a storage area in which various programs such as an operating system (OS) and an application, input data for the various programs, output data from the various programs, and the like are stored. The program stored in the ROM 102, the HDD 104, or the like is read into the RAM 103 and executed by the CPU 101, thus a function of the server apparatus 100 is realized.

Further, the server apparatus 100 includes a communication interface (communication I/F) 105 that performs communication with the outside, a display device 106 such as a display, and an input device 107 such as a keyboard, a mouse, and a touch panel.

The user terminal 200 has the same hardware configuration as the configuration illustrated in FIG. 2 as an example.

Functional Configuration of Server Apparatus

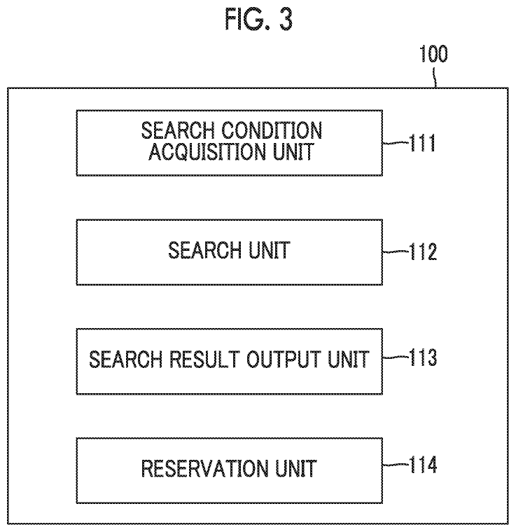

FIG. 3 is a block diagram illustrating a functional configuration example of the server apparatus 100 according to the present exemplary embodiment. The server apparatus 100 includes a search condition acquisition unit 111, a search unit 112, a search result output unit 113, and a reservation unit 114.

The search condition acquisition unit 111 as an example of an acquisition unit acquires a search condition from the user terminal 200. Specifically, in a case where a user of the user terminal 200 accesses the server apparatus 100 and inputs a search condition on a search site displayed on the user terminal 200, the search condition acquisition unit 111 acquires the search condition input by the user. In the present exemplary embodiment, the search condition is used as an example of information when the user moves from a departure place to a destination place.

Here, the search condition includes a departure place and a destination place as a place condition. The departure place is a point from which the user departs. The destination place is a point at which the user desires to arrive. Further, the search condition includes at least two pieces of information of a departure time, an arrival time, or a use time of a work place, as a time condition. The departure time is a time at which the user desires to depart from the departure place. The arrival time is a time at which the user desires to arrive at the destination place. The work place use time is a time for which the user desires to use the work place.

Hereinafter, the departure time, the arrival time, and the use time of the work place, which are input as a search condition by the user, are respectively referred to as “a desired departure time”, “a desired arrival time”, and “a desired use time”.

The search unit 112 searches a movement route from the departure place to the destination place based on the search condition acquired by the search condition acquisition unit 111. Further, the search unit 112 searches a work place which is usable when the user moves from the departure place to the destination place, the work place being a place specified based on the search condition acquired by the search condition acquisition unit 111 among a plurality of predetermined work places. At that time, the search unit 112 calculates, for each work place, a time for which work is allowed at the work place (hereinafter, referred to as “a work allowance time”).

More specifically, the search unit 112 determines whether or not the search condition acquired by the search condition acquisition unit 111 includes a departure place and a destination place. In a case where the search condition does not include a departure place and a destination place, the search unit 112 outputs an error to the user terminal 200. The error includes, for example, a message prompting the user to input a departure place and a destination place. In a case where the search condition includes a departure place and a destination place, the search unit 112 further determines whether or not the search condition includes at least two pieces of information of a desired departure time, a desired arrival time, or a desired use time of a work place.

In a case where the search condition does not include at least two pieces of information of a desired departure time, a desired arrival time, or a desired use time of a work place, the search unit 112 outputs an error to the user terminal 200. The error includes, for example, a message prompting the user to input at least two pieces of information of a desired departure time, a desired arrival time, or a desired use time of a work place.

In a case where the search condition includes at least two pieces of information of a desired departure time, a desired arrival time, or a desired use time of a work place, search processing by the search unit 112 differs depending on the included information.

Here, in a case where the search condition includes three pieces of information of a desired departure time, a desired arrival time, and a desired use time of a work place, the search unit 112 searches a movement route and a work place satisfying a condition that the user departs from the departure place after the desired departure time, a condition that the user arrives at the destination place by the desired arrival time, and a condition that the user uses the work place for the desired use time or more when the user moves from the departure place to the destination place.

In a case where the search condition includes a desired departure time and a desired arrival time and does not include a desired use time of a work place, the search unit 112 searches a movement route and a work place satisfying a condition that the user departs from the departure place after the desired departure time, a condition that the user arrives at the destination place by the desired arrival time, and a condition that the user uses the work place when the user moves from the departure place to the destination place. Here, the search unit 112 searches the work place which is usable in a remaining time obtained by excluding a movement time from a total time from the desired departure time to the desired arrival time.

In a case where the search condition includes a desired departure time and a desired use time of a work place and does not include a desired arrival time, the search unit 112 searches a movement route and a work place satisfying a condition that the user departs from the departure place after the desired departure time and a condition that the user uses the work place for the desired use time or more when the user moves from the departure place to the destination place. Here, the search unit 112 calculates, for each usable work place, an arrival time at which the user arrives at the destination place in a case where the user departs from the departure place at the desired departure time and uses the work place for the desired use time.

In a case where the search condition includes a desired arrival time and a desired use time of a work place and does not include a desired departure time, the search unit 112 searches a movement route and a work place satisfying a condition that the user arrives at the destination place by the desired arrival time and a condition that the user uses the work place for the desired use time or more when the user moves from the departure place to the destination place. Here, the search unit 112 calculates, for each usable work place, a departure time at which the user has to depart from the departure place in a case where the user uses the work place for the desired use time and arrives at the destination place by the desired arrival time.

The work place to be searched includes a work place near the destination place. The work place near the destination place may be used before the user arrives at the destination place, or may be used after the user arrives at the destination place and then arrives at the work place.

The search result output unit 113 as an example of an output unit outputs a search result by the search unit 112 to the user terminal 200. The output search result is listed on the search site and is displayed on the user terminal 200.

The reservation unit 114 reserves a work place. For example, in a case where the user performs an operation for reserving a work place, the reservation unit 114 accesses a management server (not illustrated) that manages reservations of work places and instructs the management server to reserve a work place in a time zone designated by the user. According to the instruction, processing of reserving a work place is performed by the management server.

Each functional unit of the server apparatus 100 is realized by a cooperation of a software resource and a hardware resource. Specifically, for example, in a case where the server apparatus 100 is realized by the hardware configuration illustrated in FIG. 2, various programs stored in the ROM 102, the HDD 104, and the like are read into the RAM 103 and are executed by the CPU 101. Thereby, functional units such as the search condition acquisition unit 111, the search unit 112, the search result output unit 113, and the reservation unit 114 illustrated in FIG. 3 are realized.

Processing Procedure of Server Apparatus

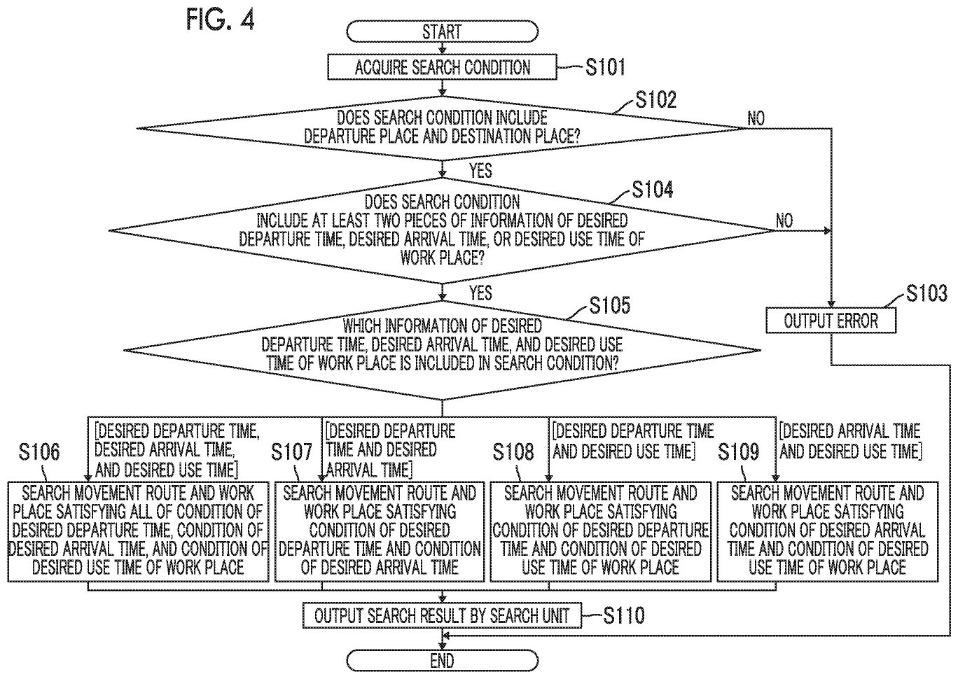

FIG. 4 is a flowchart illustrating an example of a processing procedure of the server apparatus 100 according to the present exemplary embodiment. In the example illustrated in FIG. 4, it is assumed that, in an initial state, the user terminal 200 accesses the server apparatus 100 and the search site is displayed on the user terminal 200.

In the following description, a processing step is represented by a symbol “S”.

In a case where the user inputs a search condition on the search site, the search condition acquisition unit 111 acquires the input search condition (S101). Next, the search unit 112 determines whether or not the acquired search condition includes a departure place and a destination place (3102). In a case where the determination result in S102 is NO, the search unit 112 outputs an error to the user terminal 200 (S103). The error includes, for example, a message prompting the user to input a departure place and a destination place. Then, this processing flow is ended.

On the other hand, in a case where the determination result in S102 is YES, the search unit 112 determines whether or not the acquired search condition includes at least two pieces of information of a desired departure time, a desired arrival time, or a desired use time of a work place (S104). In a case where the determination result in S104 is NO, the process proceeds to S103, and the search unit 112 outputs an error to the user terminal 200. The error includes, for example, a message prompting the user to input at least two pieces of information of a desired departure time, a desired arrival time, or a desired use time of a work place.

In a case where the determination result in S104 is YES, the search unit 112 determines which information of a desired departure time, a desired arrival time, and a desired use time of a work place is included in the search condition (S105).

In a case where it is determined that the search condition includes all of a desired departure time, a desired arrival time, and a desired use time of a work place, the search unit 112 searches a movement route and a work place satisfying all of a condition of the desired departure time, a condition of the desired arrival time, and a condition of the desired use time of the work place (S106).

In a case where it is determined that the search condition includes a desired departure time and a desired arrival time and does not include a desired use time of a work place, the search unit 112 searches a movement route and a work place satisfying a condition of the desired departure time and a condition of the desired arrival time (S107).

In a case where it is determined that the search condition includes a desired departure time and a desired use time of a work place and does not include a desired arrival time, the search unit 112 searches a movement route and a work place satisfying a condition of the desired departure time and a condition of the desired use time of the work place (S108).

In a case where itis determined that the search condition includes a desired arrival time and a desired use time of a work place and does not include a desired departure time, the search unit 112 searches a movement route and a work place satisfying a condition of the desired arrival time and a condition of the desired use time of the work place (S109).

After the steps of S106 to S109, the search result output unit 113 outputs the search result by the search unit 112 to the user terminal 200 (S110). The output search result is displayed on the user terminal 200. Then, this processing flow is ended.

Specific Example of Processing of Server Apparatus

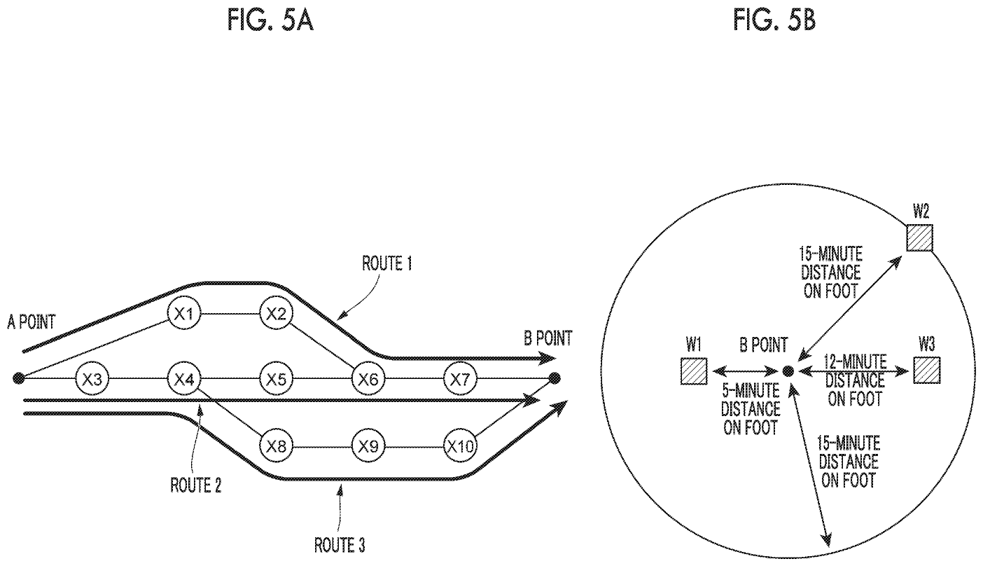

Next, processing of the search unit 112 of the server apparatus 100 will be described with a specific example. FIGS. 5A to 8B are diagrams for explaining specific examples of processing of the search unit 112 of the server apparatus 100. In the examples, a description will be given on an assumption that a route using a railroad is searched as a movement route from a departure place to a destination place. The route searching using a railroad is performed based on a predetermined railroad map and a predetermined railroad timetable.

Example in Case where Desired Departure Time, Desired Arrival Time, and Desired Use Time of Work Place are Used as Search Condition

First, a case where the desired departure time, the desired arrival time, and the desired use time of the work place are used as a search condition will be described with reference to FIGS. 5A and 5B.

In the example, the user inputs, as a search condition, an A point corresponding to a departure place and a B point corresponding to a destination place on the search site. Further, the user inputs 9:00 on Jul. 1, 2019 corresponding to a desired departure time, 12:00 on Jul. 1, 2019 corresponding to a desired arrival time, and 30 minutes corresponding to a desired use time of a work place.

Here, the search unit 112 searches a movement route and a work place satisfying a condition that the user departs from the A point after 9:00 on Jul. 1, 2019, a condition that the user arrives at the B point by 12:00 on Jul. 1, 2019, and a condition that the user uses the work place for 30 minutes or more when the user departs from the A point and arrives at the B point.

In the example, as a movement route satisfying two conditions, that is, a condition that the user departs from the A point after 9:00 on Jul. 1, 2019 and a condition that the user arrives at the B point by 12:00 on Jul. 1, 2019, as illustrated in FIG. 5A, there are three movement routes of a route 1, a route 2, and a route 3.

The route 1 is a route in which the user moves from the A point to an X1 station on foot, passes through an X2 station and an X6 station by train, and moves toward the B point from an X7 station on foot. The X6 station is a transfer station for changing trains.

The route 2 is a route in which the user moves from the A point to an X3 station on foot, passes through an X4 station, an X5 station, and the X6 station by train, and moves toward the B point from the X7 station on foot.

The route 3 is a route in which the user moves from the A point to the X3 station on foot, passes through the X4 station, an X8 station, and an X9 station by train, and moves toward the B point from an X10 station on foot. The X4 station is a transfer station for changing trains.

The search unit 112 searches a work place, which satisfies a condition of the desired departure time and a condition of the desired arrival time and is usable for 30 minutes or more, for each route.

For example, the search unit 112 specifies the departure place, the destination place, and each station on the route, as base points that exist on the route when the user moves from the departure place to the destination place. Next, the search unit 112 calculates a time for which the user can stay at the base point (hereinafter, referred to as a “stay allowance time”), for each specified base point. A remaining time obtained by excluding the desired use time of the work place from the stay allowance time is defined as a time for which a movement from the base point to the work place is allowed (hereinafter, referred to as a “movement allowance time”). A work place at which a round-trip movement from the base point to the work place is possible within the movement allowance time is set as a search target.

More specifically, for example, in a case where the route 1 is used, when the user departs from the A point at 9:00, takes a train at the X1 station, moves to the X7 station by train, and moves from the X7 station to the B point on foot, it is assumed that the user arrives at the B point at 11:00. Since the desired arrival time is 12:00, the stay allowance time at the B point is a time obtained by subtracting 11:00 from 12:00 (that is, 60 minutes). Here, since the desired use time of the work place is 30 minutes, the remaining 30 minutes obtained by subtracting the desired use time of 30 minutes from the stay allowance time of 60 minutes is the movement allowance time from the B point to the work place. Therefore, the search unit 112 searches, as a search target, a work place within a 15-minute distance from the B point on foot. In the example illustrated in FIG. 5B, three work places W1 to W3 are extracted as work places within a 15-minute distance from the B point on foot.

Next, the search unit 112 calculates a free time of each of the extracted work places based on a reservation status of the work place, and determines whether or not the work place is usable. The free time can also be regarded as the work allowance time.

For example, in a case where it takes 5 minutes from the B point to the work place W1 on foot, when the user departs from the B point at 11:00 and moves toward the work place W1, the user arrives at the work place W1 at 11:05. In order to arrive at the B point by the desired arrival time 12:00, the user has to depart from the work place W1 by 11:55. Therefore, the search unit 112 determines whether or not there is a free time for reservation in the work place W1 between 11:05 and 11:55. For example, in a case where the work place W1 is reserved between 11:00 and 11:20, a time between 11:20 and 11:55 is a free time in the work place W1, that is, a time between 11:20 and 11:55 is a work allowance time of the work place W1. In this case, since there is a free time of 30 minutes or more corresponding to the desired use time, the work place W1 is determined as a usable work place. Similarly, the search unit 112 determines whether or not the work places W2 and W3 are usable.

In this way, in a case where the route 1 is used, a work place which is usable when the B point is a base point is extracted. In addition to the B point, as the base point of the route 1, the A point, the X1 station, the X2 station, the X6 station, and the X7 station exist. Thus, a usable work place is searched for each base point. Further, in the route 2 and the route 3, similarly, usable work places are searched for each base point.

A margin may be set when calculating the movement time from the base point to the work place. For example, it is assumed that a margin of 5 minutes is set. In this case, for example, since it takes 5 minutes from the B point to the work place W1 on foot, a round-trip movement time is 10 minutes, and 15 minutes with an additional margin is set as the round-trip movement time. Further, another condition may be added to the movement time from the base point to the work place.

For example, an upper limit of the movement time to the work place may be set to 20 minutes for a round trip, and work places within a 10-minute distance from the B point on foot may be set as search targets. Under the conditions, searching of the work places may be performed.

In a case where the user uses a work place, the user may use the work place in any time zone of a free time of the work place. For example, the work place may be used immediately after the free time is started, or may be used in the second half of the free time. Here, in a case where the work place is used immediately after the free time is started, for example, the user may arrive at the destination place earlier than the desired arrival time. In addition, for example, the user may use the work place longer than the desired use time by using the remaining free time. Further, in a case where the work place is used in the second half of the free time, for example, the user may depart from the departure place later than the desired departure time.

Therefore, the search unit 112 may output the departure time, the arrival time, and the work allowance time of the work place according to which time zone of the free time the work place is used. For example, in a case where the work place is used for the desired use time from the start of the free time, the search unit 112 outputs information on an expected arrival time at which the user is expected to arrive at the destination place. For example, in a case where the work place is used longer than the desired use time from the start of the free time, the search unit 112 outputs information on an expected arrival time at which the user is expected to arrive at the destination place, according to the use time of the work place.

In a case where the work place is near the destination place, the user may stop at the work place on foot on the way from the station to the destination place, or may stop at the work place from the destination place after arriving at the destination place. Specifically, for example, in a case where the work place W1 is used, the user may stop at the work place W1 from the X7 station and move from the work place W1 to the B point, or may stop at the work place W1 from the B point and return to the B point. Depending on the positional relationship between the X7 station, the work place W1, and the B point, a total movement time may be shorter when the user stops at the work place W1 from the X7 station than when the user moves from the B point to the work place W1. Therefore, as the movement time is shortened, for example, the work allowance time of the work place may be increased, the arrival time at the destination place may be earlier than the desired arrival time, or the departure time from the departure place may be later than the desired departure time.

Similarly, even in a case where the work place is near the departure place, the user may stop at the work place on foot on the way from the departure place to the station. Even in this case, as the movement time is shortened, the work allowance time of the work place may be increased, the arrival time at the destination place may be earlier than the desired arrival time, or the departure time from the departure place may be later than the desired departure time.

Example in Case where Desired Departure Time and Desired Arrival Time are Used as Search Condition

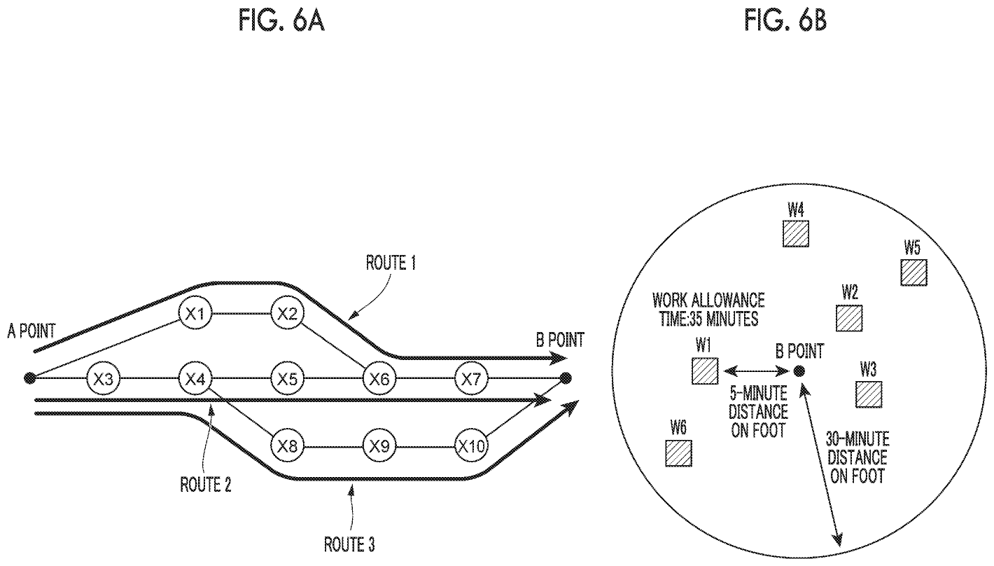

Next, a case where the desired departure time and the desired arrival time are used as a search condition will be described with reference to FIGS. 6A and 6B.

In the example, the user inputs, as a search condition, an A point corresponding to a departure place and a B point corresponding to a destination place on the search site. Further, the user inputs 9:00 on Jul. 1, 2019 corresponding to a desired departure time and 12:00 on Jul. 1, 2019 corresponding to a desired arrival time.

Here, the search unit 112 searches a movement route and a work place satisfying a condition that the user departs from the A point after 9:00 on Jul. 1, 2019 and a condition that the user arrives at the B point by 12:00 on Jul. 1, 2019.

In the example, as a movement route satisfying two conditions, that is, a condition that the user departs from the A point after 9:00 on Jul. 1, 2019 and a condition that the user arrives at the B point by 12:00 on Jul. 1, 2019, similar to the example illustrated in FIGS. 5A and 5B, there are three movement routes of a route 1 to a route 3.

The search unit 112 searches a work place, which satisfies a condition of the desired departure time and a condition of the desired arrival time and is usable, for each route. In other words, the search unit 112 searches the work place which is usable in a remaining time obtained by excluding a movement time from a total time from the desired departure time to the desired arrival time, for each route.

For example, similar to the example illustrated in FIGS. 5A and 5B, the search unit 112 specifies the departure place, the destination place, and each station on the route, as base points, for each route. Next, the search unit 112 calculates a stay allowance time for each base point. The search unit 112 calculates a free time of the work place based on the stay allowance time, a round-trip movement time from the base point to the work place, and a reservation status of the work place.

More specifically, for example, in a case where the route 1 is used, when the user departs from the A point at 9:00, takes a train at the X1 station, moves to the X7 station by train, and moves from the X7 station to the B point on foot, it is assumed that the user arrives at the B point at 11:00. Since the desired arrival time is 12:00, the stay allowance time at the B point is a time obtained by subtracting 11:00 from 12:00 (that is, 60 minutes). In this case, in a case where the work place is within a 30-minute distance from the B point on foot, the user may depart from the B point, arrive at the work place, and return to the B point within the stay allowance time. Therefore, the search unit 112 searches, as a search target, a work place within a 30-minute distance from the B point on foot. In the example illustrated in FIG. 6B, six work places W1 to W6 are extracted as work places within a 30-minute distance from the B point on foot.

Next, the search unit 112 calculates a free time of the work place based on a round-trip movement time from the base point to the work place and a reservation status of the work place, for each of the extracted work places.

For example, in a case where it takes 5 minutes from the B point to the work place W1 on foot, when the user departs from the B point at 11:00 and moves toward the work place W1, the user arrives at the work place W1 at 11:05. In order to arrive at the B point by the desired arrival time 12:00, the user has to depart from the work place W1 by 11:55. Therefore, the search unit 112 determines whether or not there is a free time for reservation in the work place W1 between 11:05 and 11:55. For example, in a case where the work place W1 is reserved between 11:00 and 11:20, a time of 35 minutes between 11:20 and 11:55 is a free time in the work place W1, that is, a time between 11:20 and 11:55 is a work allowance time of the work place W1. Similarly, the search unit 112 calculates a work allowance time of each of the work places W2 to W6.

In this way, in a case where the route 1 is used, a work place which is usable when the B point is a base point is extracted, and a work allowance time of the work place is calculated. In addition, for the other base points of the route 1, a usable work place is extracted, and a work allowance time of the work place is calculated. Further, in the route 2 and the route 3, similarly, for each base point, a usable work place is extracted, and a work allowance time of the work place is calculated.

Similar to the example illustrated in FIGS. 5A and 5B, in a case where a work place is near the departure place or the destination place, for example, when the user stops at the work place while moving on foot, the work allowance time of the work place may be increased.

Example in Case where Desired Departure Time and Desired Use Time of Work Place are Used as Search Condition

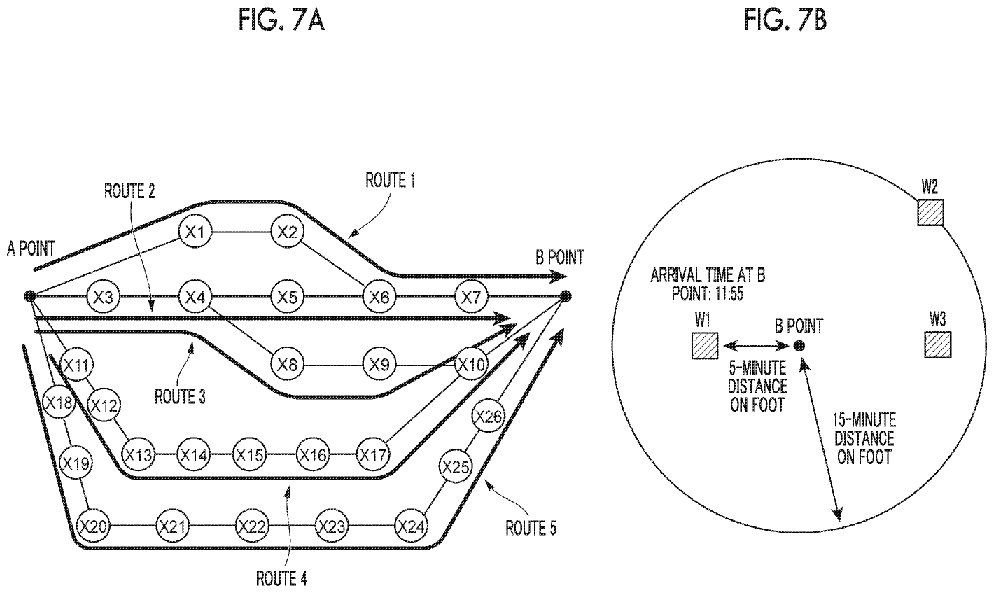

Next, a case where the desired departure time and the desired use time of the work place are used as a search condition will be described with reference to FIGS. 7A and 7B.

In the example, the user inputs, as a search condition, an A point corresponding to a departure place and a B point corresponding to a destination place on the search site. Further, the user inputs 9:00 on Jul. 1, 2019 corresponding to a desired departure time and 30 minutes corresponding to a desired use time of a work place.

Here, the search unit 112 searches a movement route and a work place satisfying a condition that the user departs from the A point after 9:00 on Jul. 1, 2019 and a condition that the user uses the work place for 30 minutes or more when the user departs from the A point and arrives at the B point.

In the example, as illustrated in FIG. 7A, there are five movement routes of a route 1 to a route 5 as movement routes from the A point to the B point. In other words, unlike the example illustrated in FIGS. 5A and 5B, since there is no limitation on the arrival time, all movement routes on which the user departs from the A point and arrives at the B point are set as search targets. On the other hand, since there may be many movement routes, the search targets may be narrowed down to movement routes satisfying a specific condition. The specific condition is, for example, a condition that top several (for example, five) movement routes with a short movement time are set as search targets, or a condition that movement routes within a specific movement time distance (for example, within 5-hour distance) are set as search targets. In the example, five movement routes satisfying the specific condition are set as search targets.

The search unit 112 searches a work place, which satisfies a condition of the desired departure time and is usable for 30 minutes or more, for each route. Further, the search unit 112 calculates, for each work place, an arrival time at which the user arrives at the destination place in a case where the user departs from the departure place at the desired departure time and uses the work place for the desired use time.

For example, similar to the example illustrated in FIGS. 5A and 5B, the search unit 112 specifies the departure place, the destination place, and each station on the route, as base points, for each route. Next, for each base point, a work place near the base point is extracted. The work place near the base point is, for example, a work place within a 15-minute distance from the base point on foot or within a 1 km distance from the base point. The search unit 112 calculates an arrival time of each of the extracted work places.

More specifically, for example, in a case where the route 1 is used, a work place near the B point is extracted. In the example, as a work place near the B point, a work place within a 15-minute distance from the B point on foot is extracted. As a result, similar to the example illustrated in FIG. 5B, three work places W1 to W3 are extracted. Further, when the user departs from the A point at 9:00, takes a train at the X1 station, moves to the X7 station by train, and moves from the X7 station to the B point on foot, it is assumed that the user arrives at the B point at 11:00. Since it takes 5 minutes from the B point to the work place W1 on foot, in a case where the user departs from the B point at 11:00 and moves toward the work place W1, the user arrives at the work place W1 at 11:05. Therefore, the search unit 112 determines whether or not there is a free time in the work place W1 after 11:05.

For example, in a case where the work place W1 is reserved between 11:00 and 11:20 and between 12:30 and 13:00, a time between 11:20 and 12:30 is a free time in the work place W1, that is, a time between 11:20 and 12:30 is a work allowance time of the work place W1. In this case, since there is a free time of 30 minutes or more corresponding to the desired use time, the search unit 112 determines that the work place W1 is usable for the free time. Further, for example, when the user uses the work place W1 for 30 minutes between 11:20 and 11:50 and departs from the work place W1 at 11:50, the arrival time at the B point is 11:55. Similarly, the search unit 112 calculates the arrival time at the B point for each of the work places W2 and W3.

In this way, in a case where the route 1 is used, a work place which is usable when the B point is a base point is extracted, and an arrival time at the destination place in a case where the work place is used is calculated. In addition, for the other base points of the route 1, a usable work place is extracted, and an arrival time at the destination place is calculated. Further, in each of the route 2 to the route 5, similarly, for each base point, a usable work place is extracted, and an arrival time at the destination place is calculated.

Similar to the example illustrated in FIGS. 5A and 5B, in a case where a work place is near the departure place or the destination place, for example, when the user stops at the work place while moving on foot, the arrival time at the destination place may be earlier than the desired arrival time.

Example in Case where Desired Arrival Time and Desired Use Time of Work Place are Used as Search Condition

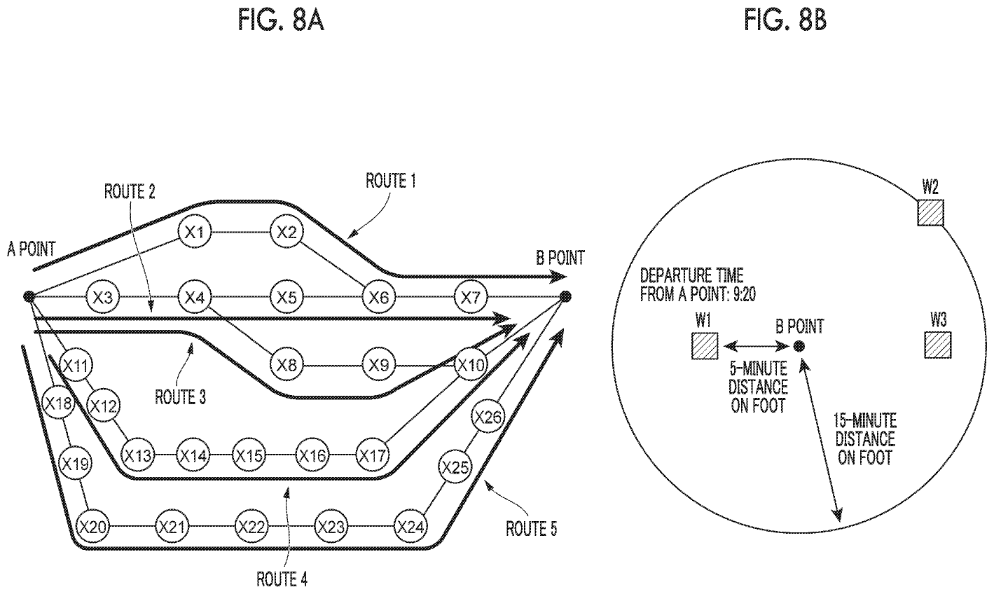

Next, a case where the desired arrival time and the desired use time of the work place are used as a search condition will be described with reference to FIGS. 8A and 8B.

In the example, the user inputs, as a search condition, an A point corresponding to a departure place and a B point corresponding to a destination place on the search site. Further, the user inputs 12:00 on Jul. 1, 2019 corresponding to a desired arrival time and 30 minutes corresponding to a desired use time of a work place.

Here, the search unit 112 searches a movement route and a work place satisfying a condition that the user arrives at the B point by 12:00 on Jul. 1, 2019 and a condition that the user uses the work place for 30 minutes or more when the user departs from the A point and arrives at the B point.

In the example, similar to the example illustrated in FIGS. 7A and 7B, there are five movement routes of a route 1 to a route 5 as movement routes from the A point to the B point. In other words, in the example, unlike the example illustrated in FIGS. 5A and 5B, since there is no limitation on the departure time, all movement routes on which the user departs from the A point and arrives at the B point are set as search targets. Here, similarly to the example illustrated in FIGS. 7A and 7B, the search targets may be narrowed down to movement routes satisfying a specific condition. In the example, five movement routes satisfying the specific condition are set as search targets.

The search unit 112 searches a work place, which satisfies a condition of the desired arrival time and is usable for 30 minutes or more, for each route. Further, the search unit 112 calculates, for each work place, a departure time at which the user has to depart from the departure place in a case where the user uses the work place for the desired use time and arrives at the destination place by the desired arrival time.

For example, similar to the example illustrated in FIGS. 5A and 5B, the search unit 112 specifies the departure place, the destination place, and each station on the route, as base points, for each route. Next, for each base point, a work place near the base point is extracted. The search unit 112 calculates a departure time of each of the extracted work places.

More specifically, for example, in a case where the route 1 is used, a work place near the B point is extracted. In the example, as a work place near the B point, a work place within a 15-minute distance from the B point on foot is extracted. As a result, similar to the example illustrated in FIG. 5B, three work places W1 to W3 are extracted. Here, it is assumed that the user stops at the B point once, moves from the B point to the work place, and then returns to the B point.

For example, in a case where the user uses the work place W1 before arriving at the B point by 12:00 corresponding to the desired arrival time, since it takes 5 minutes from the work place W1 to the B point on foot, the user has to depart from the work place W1 by 11:55. Therefore, the search unit 112 determines whether or not there is a free time in the work place W1 before 11:55.

For example, in a case where the work place W1 is reserved between 11:00 and 11:20, a time between 11:20 and 11:55 is a free time in the work place W1, that is, a time between 11:20 and 11:55 is a work allowance time of the work place W1. In this case, since there is a free time of 30 minutes or more corresponding to the desired use time, the search unit 112 determines that the work place W1 is usable for the free time. For example, in a case where the user uses the work place W1 for 30 minutes from 11:25 to 11:55, the user may arrive at the work place W1 at 11:25. That is, the user may stop at the B point, depart from the B point at 11:20, and move toward the work place W1. Therefore, in the case where the route 1 is used, considering the movement time on the railroad, the search unit 112 calculates a departure time at which the user has to depart from the A point in order to arrive at the B point by 11:20, as, for example, 9:20. Similarly, the search unit 112 calculates a departure time at which the user has to depart from the A point, for each of the work places W2 and W3.

In this way, in a case where the route 1 is used, a work place which is usable when the B point is a base point is extracted, and a departure time at which the user has to depart from the departure place when the work place is used is calculated. In addition, for the other base points of the route 1, a usable work place is extracted, and a departure time at the departure place is calculated. Further, in each of the route 2 to the route 5, similarly, for each base point, a usable work place is extracted, and a departure time at the departure place is calculated.

Similar to the example illustrated in FIGS. 5A and 5B, in a case where a work place is near the departure place or the destination place, for example, in a case where the user stops at the work place while moving on foot, the departure time at the departure place may be later than the desired arrival time.

Here, in the examples illustrated in FIGS. 5A to 8B, the case where the B point is set as abase point has been described. On the other hand, the same processing is performed in a case where another point is set as a base point. For example, in a case where the route 1 is used and the X2 station is set as abase point, the user gets off the train once at the X2 station, moves from the X2 station to the work place, uses the work place, and returns to the X2 station, takes a train again at the X2 station, and moves toward the B point by train. In the case where the route 1 is used, the X6 station is a transfer station. In a case where the X6 station is set as abase point, similarly, the user gets off the train once at the X6 station, moves from the X6 station to the work place, uses the work place, and returns to the X6 station, takes a train again at the X6 station, and moves toward the B point by train. Here, a movement time from the X6 station to the work place may include a transfer time of the train at the X6 station.

Further, the user may select a movement route. For example, in the example illustrated in FIGS. 5A and 5B, there are three movement routes of the route 1 to the route 3, and the user may select one or more routes among the route 1 to the route 3, as routes to be used. At that time, as reference information, information on a movement time and a transportation cost of each route may be presented to the user.

Further, the user may set a plurality of destination places. For example, the user may depart from a departure place, move to a destination place, and then move to another destination place. In some cases, the user may depart from the departure place and move to the destination place, and then return to the departure place. For example, in a case where the user sets two destination places, similar to a case of a movement from a departure place to a first destination place, as a search condition of a movement from the first destination place to a second destination place, the user sets at least two pieces of information of a desired departure time at the first destination place, a desired arrival time at the second destination place, or a desired use time of a work place.

In the present exemplary embodiment, a processing procedure of searching a movement route and a work place is not limited to the examples illustrated in FIGS. 5A to 8B. Any procedure may be used as long as a movement route and a work place can be searched according to the search condition input by the user. For example, instead of searching a work place for each base point of each route according to the search condition, a method of searching a movement route for each work place and determining whether or not the work place is usable may be used.

Display Example of Search Result

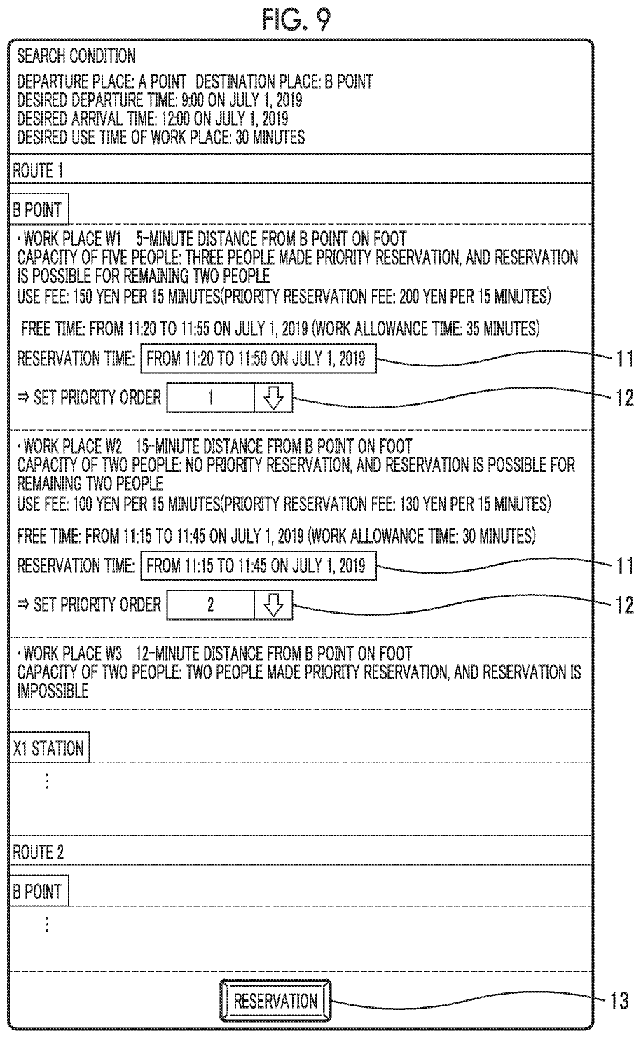

Next, a display example of a search result by the search unit 112 will be described. FIGS. 9 to 12 are diagrams illustrating display examples of search results. Here, a case where searching is performed using the search conditions described in FIGS. 5A to 8B will be described.

Example in Case where Desired Departure Time, Desired Arrival Time, and Desired Use Time of Work Place are Used as Search Condition

First, a case where the desired departure time, the desired arrival time, and the desired use time of the work place are used as a search condition will be described with reference to FIG. 9. Here, by performing searching under the search condition illustrated in FIGS. 5A and 5B, information on the work place is displayed on the search site for each base point of each of the route 1 to the route 3.

For example, on the route 1, in a case where the B point is set as a base point, there are work places W1 to W3. The work place W1 is within a 5-minute distance from the B point on foot, and has a capacity of five people. Further, based on a reservation status, three people made a priority reservation for the work place W1, and thus a reservation is possible for remaining two people. The priority reservation is a reservation by which the user can use a work place with higher priority than a normal reservation. A use fee is 150 Yen per 15 minutes. Here, when the user pays 200 Yen per 15 minutes, the user can make a priority reservation.

Based on a search result, a free time of the work place W1 is a time from 11:20 to 11:55 on Jul. 1, 2019, and a work allowance time of the work place W1 is 35 minutes. In a case where the user makes a reservation for the work place W1, the user may input a reservation time in a reservation time input field 11. In the example illustrated in FIG. 9, a time from 11:20 to 11:50 is input as a reservation time for the work place W1. The user may input a time longer than 30 minutes corresponding to the desired use time, or may input a time shorter than 30 minutes, as the reservation time for the work place W1.

Further, even in a case where a user makes a reservation for a work place and then another user makes a priority reservation for the work place, the user of the priority reservation uses the work place by priority. Therefore, in an item 12, the user can set a priority order for the work place to be reserved. In the example illustrated in FIG. 9, the priority of the work place W1 is set as the first, and the priority of the work place W2 is set as the second.

In a case of the work place W3, two people made a priority reservation, and there is no free time satisfying the search condition. Therefore, reservation is not possible.

In a case where the user selects a reservation button 13, the reservation unit 114 reserves a work place. Here, the reservation of the work place is confirmed, for example, on the reservation day (for example, 6:00 am on the reservation day). Until the reservation is confirmed, the user can make a normal reservation or a priority reservation for the work place while browsing the search site.

In the example illustrated in FIG. 9, although pieces of information on the work places are listed and displayed for each base point of each route, the order in which the pieces of information on the work places are listed is not limited. For example, a priority may be given to work places with a short distance from the base point, and the work places may be listed in order from the top. Alternately, a priority may be given to work places at which a transportation fee or a use fee is low, and the work places may be listed in order from the top. In addition, for example, a priority may be given to work places with a long work allowance time, and the work places may be listed in order from the top. Alternately, a priority may be given to work places for which a large number of persons make a reservation, and the work places may be listed in order from the top. Further, the pieces of information on the work places may be classified and displayed according to environmental conditions of the work places. For example, the pieces of information on the work places may be classified and displayed according to work place types such as a restaurant and a work space.

Example in Case where Desired Departure Time and Desired Arrival Time are Used as Search Condition

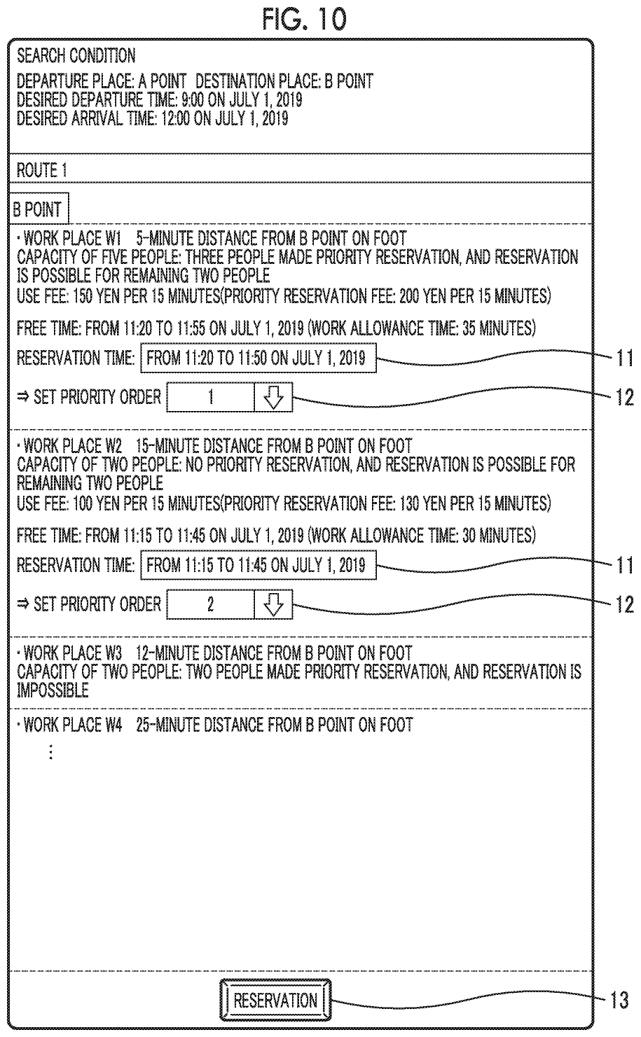

Next, a case where the desired departure time and the desired arrival time are used as a search condition will be described with reference to FIG. 10. Here, by performing searching under the search condition illustrated in FIGS. 6A and 6B, information on the work place is displayed on the search site for each base point of each of the route 1 to the route 3.

For example, on the route 1, in a case where the B point is set as a base point, there are work places W1 to W6, and thus information on each of the work places W1 to W6 is displayed.

The information on the work place is identical with the information in the example illustrated in FIG. 9, and thus a description thereof will be omitted.

Example in Case where Desired Departure Time and Desired Use Time of Work Place are Used as Search Condition

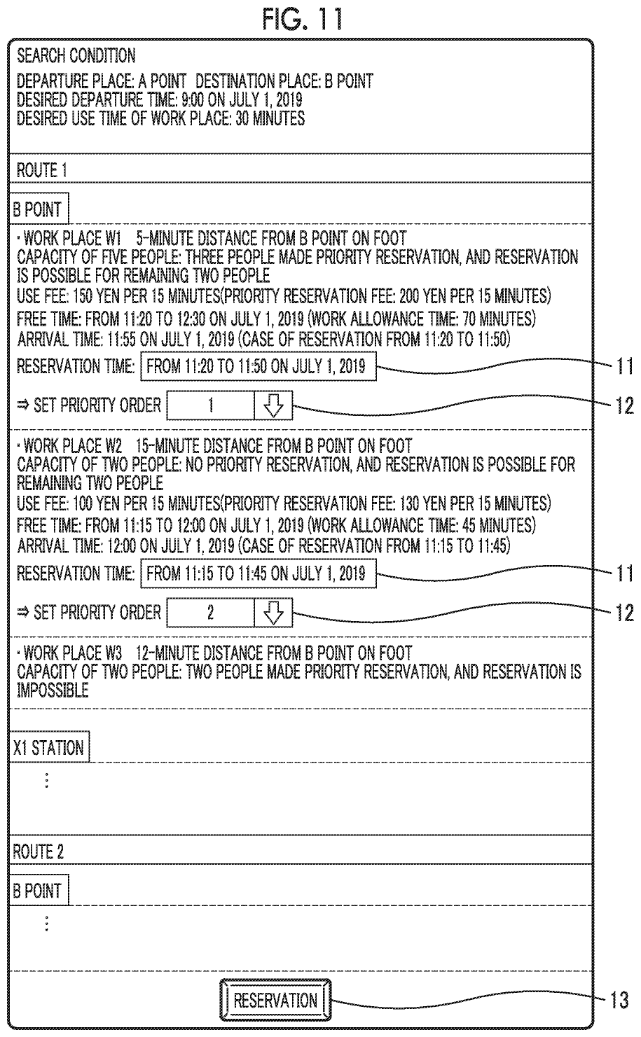

Next, a case where the desired departure time and the desired use time of the work place are used as a search condition will be described with reference to FIG. 11. Here, by performing searching under the search condition illustrated in FIGS. 7A and 7B, information on the work place is displayed on the search site for each base point of each of the route 1 to the route 5.

The displayed information is different from the information in the example illustrated in FIG. 9 in that the arrival time is displayed for each usable work place. For example, in the work place W1, a free time is a time from 11:20 to 12:30 on Jul. 1, 2019. Here, in a case where the user makes a reservation for the work place W1 for 30 minutes from 11:20 to 11:50, the information indicates that the arrival time at the B point is 11:55.

The other information is identical with the information in the example illustrated in FIG. 9, and thus a description thereof will be omitted.

Example in Case where Desired Arrival Time and Desired Use Time of Work Place are Used as Search Condition

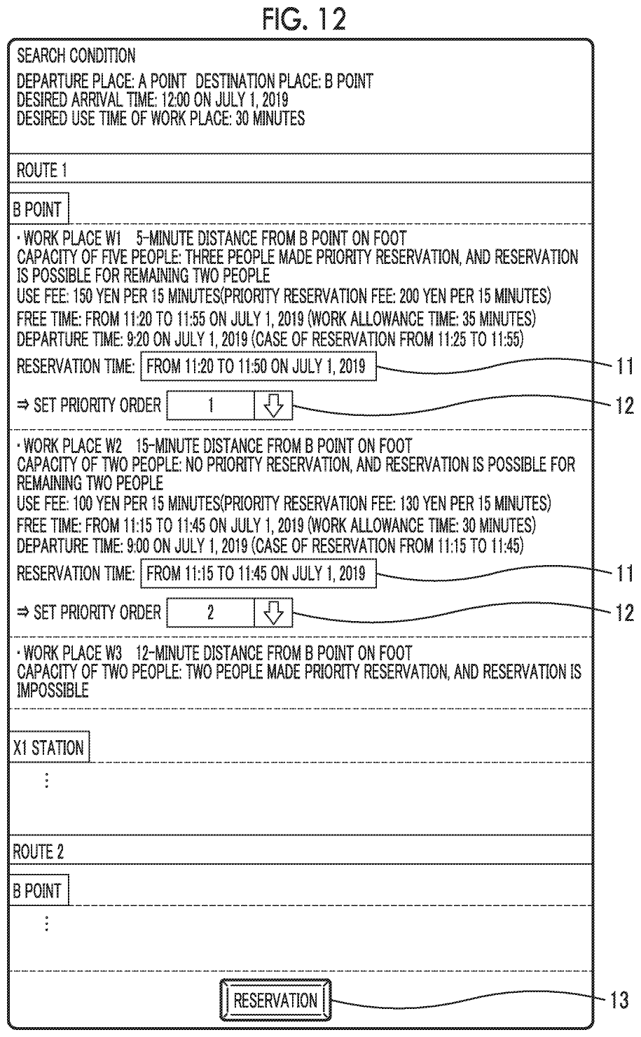

Next, a case where the desired arrival time and the desired use time of the work place are used as a search condition will be described with reference to FIG. 12. Here, by performing searching under the search condition illustrated in FIGS. 8A and 8B, information on the work place is displayed on the search site for each base point of each of the route 1 to the route 5.

The displayed information is different from the information in the example illustrated in FIG. 9 in that the departure time is displayed for each usable work place. For example, in the work place W1, a free time is a time from 11:20 to 11:55 on Jul. 1, 2019. Here, in a case where the user makes a reservation for the work place W1 for 30 minutes from 11:25 to 11:55, the information indicates that the user has to depart from the A point at 9:20 corresponding to the departure time in order to arrive at the B point by 12:00.

The other information is identical with the information in the example illustrated in FIG. 9, and thus a description thereof will be omitted.

Display Example in Case where Position of Work Place is Displayed on Map

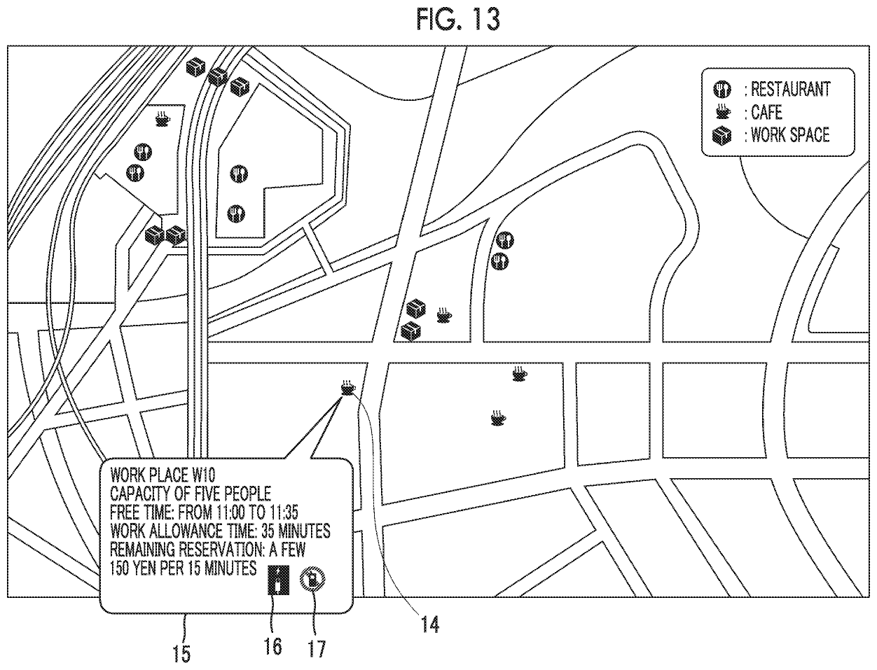

In the present exemplary embodiment, a position of the work place may be displayed on a map, as a search result. FIG. 13 is a diagram illustrating a display example in a case where a position of a work place is displayed on a map.

In the example, an image indicating a type of the work place is mapped at a position of the work place. For example, an image indicating each of a restaurant, a cafe, and a work space is prepared, and an image indicating any one of a restaurant, a cafe, and a work space is mapped according to a type of the work place. An image 14 is an image indicating a position of the work place W10. The image 14 is an image indicating a cafe, and indicates that the work place W10 is a cafe.

In a case where the user selects the image 14, an image 15 including information on the work place is displayed. The image 15 indicates that the work place W10 has a capacity of five people, that the free time is a time from 11:00 to 11:35 and the work allowance time is 35 minutes, that a few reservations are possible, and that the use fee is 150 Yen per 15 minutes. An image 16 is an image indicating that charging is possible at the work place W10. An image 17 is an image indicating that a telephone call is not allowed at the work place W10.

Here, when the user inputs a condition, a color of the image of the work place matching with the condition may be changed, or only the image of the work place matching with the condition may be displayed. The input condition is, for example, a condition related to a transportation fee or a use fee of the work place, a condition related to availability of the work place, or a condition indicating whether or not charging is possible.

The map illustrated in FIG. 13 is displayed together with the information of the work place illustrated in FIGS. 9 to 12. Further, the map illustrated in FIG. 13 may be displayed by being switched from the screens illustrated in FIGS. 9 to 12.

### Other Configuration Examples

Next, other configuration examples of the present exemplary embodiment will be described.

As a result of the searching, in a case where there is no usable work place, the search unit 112 may prompt the user to change the search condition. In addition, the reservation unit 114 may prompt the user to wait for a reservation cancellation. In this case, the user may select a work place that cannot be reserved at the present time, and set waiting for a reservation cancellation. Here, the user may collectively set waiting for reservation cancellations of a plurality of work places near a base point by selecting the base point, instead of selecting the work places. In a case where there is a usable work place in a time zone designated by the user, the reservation unit 114 reserves the work place, and notifies the user that the work place is reserved. In a case where a plurality of users are waiting for a reservation cancellation at the same work place or the same base point, a priority is given to a user who is waiting for a reservation cancellation first, and the work place is reserved for the user with priority.

Further, the reservation unit 114 may reserve a transportation facility as well as a work place. In other words, in a case where a work place to be reserved is determined, a movement route from a departure place to a destination place is determined. Therefore, the reservation unit 114 reserves a transportation facility such that the user can use a work place to be reserved, based on a route map of a transportation facility and a timetable of a transportation facility.

Further, after the user reserves a work place, the reserved work place may not be used. Therefore, the reservation unit 114 may notify the user of a use of the work place before a start time of the reserved time zone (for example, 30 minutes before the start time), and cancel the reservation in a case where there is no response to the notification from the user. The reservation cancellation mechanism may be enabled in a case where the user permits a use of the mechanism in advance.

In a case where the user requests changing of a reservation of a work place, the reservation unit 114 may cancel the reservation of the work place and reserve another work place. In this case, in a case where the user inputs a changed search condition, the search unit 112 searches a movement route and a work place based on the input search condition. In a case where there is a usable work place on the same movement route as the movement route of the canceled reservation, the search unit 112 reserves the work place. In this case, there is no change in the movement route. On the other hand, in a case where there is no usable work place on the same movement route as the movement route of the canceled reservation, the search unit 112 searches a work place on another movement route. In this case, the movement route is changed. Thus, in a case where a transportation facility is already reserved, the reservation unit 114 may cancel the reservation of the transportation facility, and reserve a transportation facility on the new movement route.

In the above-described examples, the search unit 112 determines whether or not the work place is usable in consideration of the reservation status of the work place. Here, in the present exemplary embodiment, the reservation status of the work place may not be considered. In a case where the reservation status of the work place is not considered, even when the work place is already reserved and is not actually usable, the work place is regarded as being usable as long as the user can arrive at the work place. For example, in a case where the desired departure time, the desired arrival time, and the desired use time of the work place are used as a search condition, when a stay allowance time at a certain base point is 60 minutes and a round-trip movement time from the base point to the work place is 10 minutes, regardless of the reservation status of the work place, a free time (that is, a work allowance time) of the work place is calculated as 50 minutes.

Further, in the above-described examples, as the search condition, a desired use time is used. On the other hand, the desired use time is a desired time for using the work place, and does not include a movement time from the base point to the work place. Therefore, in the present exemplary embodiment, a time including the movement time from the base point to the work place, in other words, a time that the user can spend to perform work at the work place when moving from the departure place to the destination place, may be used as a search condition. In this case, the user inputs the time as a search condition. The time that the user can spend to perform work at the work place is used as an example of a use time of the work place.

In the above-described examples, although a railroad is used for movement, a transportation facility used for movement is not limited to the railroad. For example, in a case where an airplane, a ship, or a bus is used for movement, a movement route of the transportation facility and a work place may be searched.

Further, the transportation facility used for movement is not limited to a public transportation facility. For example, in a case where a car or a bicycle driven by the user himself/herself is used for movement, a movement route of the car or the bicycle and a work place may be searched.

In addition, a plurality of types of transportation facilities may be used for movement. Further, in a case where the user moves on foot without using a transportation facility, a movement route and a work place may be searched.

In the above-described examples, although the server apparatus 100 outputs information on a movement route and a work place using the search site, the present invention is not limited to the configuration using the search site. For example, when the user terminal 200 executes an application program and communicates with the server apparatus 100, the server apparatus 100 may output information on a movement route and a work place. Further, some of the functional units of the server apparatus 100 may be realized by another apparatus such as the user terminal 200.

The program for realizing the exemplary embodiment of the present invention may be provided by a communication unit, and may be provided by being recorded in a computer-readable recording medium such as a semiconductor memory.

As described above, the exemplary embodiment and the modification examples have been described, but the exemplary embodiment and the modification examples may be combined with each other as appropriate.

Further, the present disclosure is not limited to the exemplary embodiment, and may be embodied in a variety of other forms without departing from the spirit of the present disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
an acquisition unit that acquires at least two pieces of information of a departure time, an arrival time, or a use time of a work place, as information when a user moves from a departure place to a destination place; and
an output unit that outputs information on a usable work place together with information on a work allowance time of the usable work place, the usable work place being a place that is usable when the user moves from the departure place to the destination place, the usable work place being specified, from among a plurality of predetermined work places, based on the information acquired by the acquisition unit.

2. The information processing system according to claim 1,
wherein the acquisition unit acquires pieces of information of the departure time and the arrival time, and
wherein the output unit outputs information on the usable work place which is usable in a remaining time obtained by excluding a movement time from a total time from the departure time to the arrival time together with information on the work allowance time of the usable work place.

3. The information processing system according to claim 2,
wherein the output unit outputs, as the information on the work allowance time of the usable work place, information on a time for which a reservation of the usable work place is possible within the remaining time, for each the usable work place.

4. The information processing system according to claim 1,
wherein the acquisition unit acquires pieces of information on the departure time and the use time of the work place, and
wherein the output unit outputs information on an arrival time at which the user arrives at the destination place in a case where the user departs from the departure place at the departure time and uses the usable work place for the use time, for each the usable work place.

5. The information processing system according to claim 4,
wherein the output unit outputs, as the information on the arrival time, information on a time at which the user arrives at the destination place after using the usable work place for the use time in a time zone in which a reservation of the usable work place is possible, for each the usable work place.

6. The information processing system according to claim 1,
wherein the acquisition unit acquires pieces of information on the arrival time and the use time of the work place, and
wherein the output unit outputs information on a departure time at which the user has to depart from the departure place in a case where the user uses the usable work place for the use time and arrives at the destination place by the arrival time, for each the usable work place.

7. The information processing system according to claim 6,
wherein the output unit outputs, as the information on the departure time, information on a time at which the user has to depart from the departure place before using the usable work place for the use time in a time zone in which a reservation of the usable work place is possible, for each the usable work place.

8. The information processing system according to claim 1,
wherein the output unit outputs information on the usable work place, for each base point of a plurality of base points existing between the departure place and the destination place.

9. The information processing system according to claim 8,
wherein the output unit outputs, as the information on the usable work place, information on the work place at which a movement from the base point is possible and of which a reservation is possible when the user moves from the departure place to the destination place based on the information acquired by the acquisition unit, for each base point of the plurality of base points.

10. An information processing system comprising:
an acquisition unit that acquires pieces of information of a departure time, an arrival time, and a use time of a work place, as information when a user moves from a departure place to a destination place; and
an output unit that outputs information on a usable work place which is usable when the user moves from the departure place to the destination place, the usable work place being specified based on the information acquired by the acquisition unit among a plurality of predetermined work places.

11. A non-transitory computer readable medium storing a program causing a computer to realize:
a function of acquiring at least two pieces of information of a departure time, an arrival time, or a use time of a work place, as information when a user moves from a departure place to a destination place; and
a function of outputting information on a usable work place together with information on a work allowance time of the usable work place, the usable work place being a place that is usable when the user moves from the departure place to the destination place, the usable work place being specified, from among a plurality of predetermined work places, based on the information acquired by the acquisition unit.

12. A non-transitory computer readable medium storing a program causing a computer to realize:
a function of acquiring pieces of information of a departure time, an arrival time, and a use time of a work place, as information when a user moves from a departure place to a destination place; and
a function of outputting information on a usable work place, the usable work place being a place that is usable when the user moves from the departure place to the destination place, the usable work place being specified, from among a plurality of predetermined work places, based on the information acquired by the acquisition unit.
